(19) United States
(12) Patent Application Publication
(10) Pub. No.: US 2007/0062369 A1
(43) Pub. Date: Mar. 22, 2007

(54) Method for the production of shaped zeolites, and method for eliminating impurities from a gas stream (as amended)

(75) Inventors: Armin Pfenninger, Uetikon am See (CH); Sonja Odolo-Hitz, Zug (CH)

Correspondence Address: BANNER & WITCOFF, LTD., TEN SOUTH WACKER DRIVE, SUITE 3000, CHICAGO, IL, 60606, US

(73) Assignee: ZEOCHEM AG, Uetikon am See (CH)

(21) Appl. No.: 10/553,119

(22) PCT Filed: Apr. 7, 2004
(86) PCT No.: PCT/CH04/00217

§ 371 Date: Nov. 7, 2006

(30) Foreign Application Priority Data
Apr. 14, 2003 (EP) 03008047.7

(51) Int. Cl. B01D 53/02

(52) U.S. Cl. 95/90; 502/60; 423/700

(57) ABSTRACT

Disclosed is a synthetic zeolite by means of which gas streams containing steam and carbon dioxide as impurities can be purified. The zeolitic adsorbing agent is a 13X type or LSX type faujasite or a mixture of both types that are deformed with a binder, at least some parts of which are highly dispersed. Said novel adsorption system allows extraordinarily high adsorption capacities to be obtained while keeping the mass transfer zones short resulting in a longer service life of the adsorption systems before carbon dioxide is able to break through.

### INFORMATION ON RELATED APPLICATIONS

This Application claims the priority of European Patent Application 03 008 047.7, which was filed on Apr. 14, 2003 and the entire disclosure of which is hereby incorporated by reference.

### FIELD OF THE INVENTION

The present invention relates to a method for the production of a shaped synthetic zeolite by means of which gas streams which contain steam and carbon dioxide as an impurity can be purified, to the zeolite itself and to the use thereof for gas purification. In particular, the invention relates to a zeolite in which the zeolitic adsorbent is shaped with a binder which comprises finely divided attapulgite binder.

### PRIOR ART

Zeolites are hydrated aluminosilicates having the general chemical formula

M_{2/n}O.Al₂O₃.xSiO₂.yH₂O

in which

M is usually a metal of the alkali metal or alkaline earth metal group,

n is the valency of the metal,

x is a number which—depending on the structure type of the zeolite—may vary between 2 and infinity, and

y is finally the hydrated status of the zeolite.

Most zeolites form three-dimensional crystals, it being possible for the crystals to assume a size of from 0.1 to 30 μm. If the zeolites are heated, they continuously release the adsorbed water, leaving a three-dimensional crystalline structure which has channels and pore openings of molecular dimension. This leads to a large internal surface area which is suitable for the adsorption of inorganic and organic molecules. The adsorption of these molecules is limited only by the size of the channels and pore openings of the zeolite.

The use of these zeolites is limited by the fact that the crystals form very small particles. Any naturally formed agglomerates are not stable and immediately disintegrate again under mechanical stress. The dynamic applications known today, such as, for example, the drying of natural gas, the drying of air, the separation of impurities from a gas stream, the separation of substances of a liquid or gaseous product stream, requires as a rule large amounts of adsorbents. Zeolite beds comprising these small particles cannot be used in practice for adsorption applications since the back-pressure is very high even in the case of small columns. The zeolite crystals are, as a rule, therefore shaped and consolidated with an inert binder. Consequently, adsorption systems having a very much lower back-pressure are achieved.

A frequently used binder is attapulgite clay, which is still mainly present in the form of fiber bundles after the application of customary comminution methods and is used in this form. Zeolites which are shaped with attapulgite are described, for example, in DE 1 055 515, US 2001/0049998, EP 0 949 174, U.S. Pat. No. 4,181,508, DE 1 040 005 and JP 11 245282, JP 2000 211 915 and JP 2000 210 557.

U.S. Pat. No. 5,856,264 describes a method for the production of a special shaped zeolite which is suitable as insulation for window panes. According to this method, an aqueous attapulgite dispersion is prepared and the dispersion is mixed with the zeolite and then sprayed. This document states neither how an attapulgite could be rendered finely divided nor which properties a finely divided attapulgite might have or has.

The faujasites having an SiO₂/Al₂O₃ ratio of 2.3-3.0 are usually designated as zeolite 13X and those having an SiO₂/Al₂O₃ ratio of 2.0-2.3 frequently as LSX (low silica X zeolite), it not being possible exactly to specify the transition from zeolite LSX to zeolite 13X. The synthesis of zeolite 13X was described in U.S. Pat. No. 2,882,244, and the synthesis of zeolite LSX in GB Patent 1,051,621.

The early use of synthetic faujasites consisted in the purification of air or other gas mixtures before they were fed to a low-temperature distillation or other process steps. Removal of steam and of carbon dioxide from air is particularly important since these two trace gases condense and freeze on cooling and thus make the low-temperature distillation of nitrogen and oxygen impossible.

U.S. Pat. No. 3,078,639 describes the use of synthetic faujasites for the purification of air, the SiO₂/Al₂O₃ ratio in the faujasite being stated as 2.5±0.5. Zeolites are used either as crystalline powders or as moldings, an unspecified binder having been used for the production of the molding.

The use of synthetic faujasites having an SiO₂/Al₂O₃ ratio between 2.0 and 2.3 proved to be particularly advantageous because the adsorption capacity of carbon dioxide was particularly high, especially at low partial pressures. U.S. Pat. No. 5,531,808 demonstrates the higher adsorption capacity of carbon dioxide on LSX zeolites compared with a zeolite 13X.

The zeolites proved to be particularly advantageous when they were present in their sodium form. This aspect is described in detail in WO 00/01478.

If, in the shaped material, a part of the binder is converted into zeolite LSX in a subsequent treatment with aqueous sodium hydroxide solution, the adsorption capacity of the shaped zeolite improves further. In addition, according to WO 99/46031, the adsorbed carbon dioxide can be desorbed at a lower temperature.

WO 01/24923 describes the behavior or zeolite mixtures which were prepared from zeolite 13X and zeolite LSX. The adsorptivity of these mixtures is greater than would be expected from calculations, in particular at low partial pressures. The exchangeable cations can be varied within wide limits.

The separation of the impurities from the gas stream can be effected in various ways. If carbon dioxide and steam are to be adsorbed as trace elements, the regeneration of the adsorption system is effected as a rule thermally. In this case, the term TSA (temperature swing adsorption) process is used. Alternatively, the adsorption and regeneration of the adsorption bed can also be effected by pressure change. This process is then referred to as PSA (pressure swing adsorption). The removal of the impurities can be effected in an adsorption column which is filled with a suitable adsorbent. Alternatively, the adsorption column can be filled with various layers of adsorbents in order to separate off individual impurities in succession and selectively. Possible experimental arrangements are described in WO 96/14916, EP 1 092 465 and U.S. Pat. No. 6,106,593.

An object of the present invention was to improve the classical process by means of which carbon dioxide is removed by selective adsorption by a gas stream, especially air.

### SUMMARY OF THE INVENTION

A subject of the present method is therefore the provision of a method for the production of a shaped zeolite having improved carbon dioxide adsorption.

The invention furthermore relates to a shaped zeolite obtainable by this method and a gas purification process using this zeolite.

This object was achieved by means of a method for the production of shaped zeolites, which is characterized by the process steps

a) mixing of (i) at least one type of zeolite crystal from the faujasite family having an SiO₂/Al₂O₃ ratio of ≦3.0, in particular zeolite LSX or zeolite LSX and zeolite 13X, with (ii) finely divided attapulgite binder or finely divided attapulgite binder and at least one further clay binder and (iii) addition of water,

b) production of shaped zeolite bodies from the mixture prepared in step a),

c) drying and calcination of the zeolite bodies shaped in step a) in order to obtain the active adsorbent,

the finely divided attapulgite binder being characterized in that its bulk density, measured according to EN ISO 797:1995D, is greater than 550 g/l.

In addition to carbon dioxide, water and other inorganic gases and hydrocarbons, which may also be present in the gas stream, can likewise be selectively bound to an adsorbent and removed. According to the object of the invention, as small as possible an amount of adsorbent should be able to be used for a certain amount of gases to be purified. As a result, inter alia, the regeneration times of the adsorbent and hence the total cost of the purification process can be reduced. The purified gases are as a rule then subjected to a cryogenic distillation.

All developments to date concentrate on increasing the adsorption capacity at low partial pressures of carbon dioxide. In order to achieve this, the zeolite or the zeolite mixture was optimized. It was found that the faujasites having a lower SiO₂/Al₂O₃ ratio have a higher adsorption capacity for carbon dioxide than those having a higher SiO₂/Al₂O₃ ratio. Additional adsorption capacity could be obtained when a part of the binder was converted into zeolite in a separate reaction step. With the exception of this converted clay binder, the role of the clay binder in the adsorption process was scarcely taken into account, if at all, in all these works.

It has now been found that not only the adsorption capacity but also the adsorption kinetics are important for assessing the adsorption process. The adsorption kinetics have not been taken into account to date in any proposal for improvement. Said adsorption kinetics can be determined using a flow-through apparatus, it being possible to determine firstly the breakthrough time and secondly the mass transfer zone. The breakthrough time at low partial pressures is then dependent on the adsorption capacity and on the adsorption kinetics.

It has now been found that, by optimizing the zeolites and clay binders used, the breakthrough time for carbon dioxide can be substantially increased. In particular, the application of a finely divided attapulgite binder—also in small amounts—to a zeolite system comprising zeolite 13X and zeolite LSX led to adsorption behavior which was not foreseeable. While zeolites 13X and LSX are preferred, the advantages of the invention can also be realized with other zeolites of the faujasite type.

Clay particles, in particular attapulgite clay particles, exist as dense materials having very limited adsorption capacity. These conventional clay binder particles differ in size and shape from the zeolite particles. If they are mixed with zeolite crystals, they tend to occupy sites between the zeolite crystals and they can contribute to the adsorption by the zeolite material without improving the general adsorption of the zeolite mixture. In particular, after recovery and working-up, attapulgite particles are still present in the form of dense bundles of agglomerated bristles. Such bundles were confirmed by means of scanning electron microscopy (SEM). To enable attapulgite to be used as a binder for zeolite particles, these bristles must be separated or ground. Without grinding of these attapulgite clay particles to a smaller size, a nonporous layer of attapulgite clay particles forms in the zeolite mixture and prevents or at least substantially limits the diffusion of the substances to be adsorbed through the mixture. The conventional attapulgite clays used to date are prepared by dry milling of the attapulgite clay. In the conventional method, these dry-milled bristle bundles of the attapulgite clay are mixed with the zeolite crystals. Even after the conventional milling of the attapulgite clay, large bundles of attapulgite bristles are still present. If these conventionally comminuted attapulgite clay bundles are mixed with zeolite and shaped to give an adsorbent, the ability of the zeolite material to adsorb the desired adsorbates is not substantially increased.

According to the invention, instead of such a conventional clay binder material, finely divided attapulgite clay is used as a binder.

In the context of the present invention, finely divided attapulgite binder is understood as meaning a purified magnesium aluminum silicate which contains sodium polyacrylate as a dispersant and was rendered self-dispersing by chemical processes.

The difference between conventional, dense attapulgite clay and the finely divided attapulgite clay particles which are used according to the invention can be shown by means of scanning electron microscopy. Another method for distinguishing between conventionally dense attapulgite clay and the finely divided attapulgite clay products is the bulk density, measured according to EN ISO 787:1995D. Dense attapulgite clay binders have a residual water content of about 20 to 25% and they have a bulk density of about 400 g/liter to about 530 g/liter. Finely divided attapulgite binders likewise have a residual water content of about 20 to 25% but have a bulk density of about 550 g/liter to about 700 g/liter.

Another method for distinguishing between conventional dense attapulgite clays and finely divided attapulgite clay products is the determination of the water adsorption capacity of the attapulgite clay products. In order to determine whether the clay binder is finely divided, the clay binder is saturated at 50% relative humidity and at 25° C. until the equilibrium adsorption capacity has been reached. This method can take up to 72 hours. After complete hydration of the clay, the clay is dried at 550° C. for at least 2 hours. The difference between the weight of the completely hydrated clay and the dried clay is the water adsorptivity. For dense attapulgite clays, the water adsorptivity is less than 30%, whereas this is above 35% for finely divided attapulgite clay.

A preparation method whose aim was to separate other clay types from attapulgite is described in U.S. Pat. No. 6,130,179. The finely divided attapulgite binder which is obtainable by this method contains finely divided attapulgite fibers and has a bulk density, measured according to EN ISO 787:1995D, of at least 550 g/l and a water adsorption capacity of more than 35% by weight.

Further developments, advantages and applications of the invention are evident from the dependent claims and from the following description.

### BRIEF DESCRIPTION OF THE DRAWING

The advantage of the subject matter of the present invention is evident, inter alia, from FIG. 1.

FIG. 1 shows the breakthrough times of carbon dioxide as a function of the chosen binder and of the zeolite composition.

### DESCRIPTION OF THE PREFERRED EMBODIMENTS

If zeolite 13X is replaced by zeolite LSX, an increase in the breakthrough time can be assumed since the zeolite LSX has a higher adsorption capacity than zeolite 13X. The breakthrough time for a zeolite 13X which was prepared using a conventional clay binder is 158 minutes. If the zeolite 13X is replaced by zeolite LSX, the breakthrough time increases to 213 minutes. The increase in the breakthrough time is 35%. EP 0 930 089 describes an analogous experiment. There, an increase in the breakthrough time by 43% was determined on replacing a zeolite 13X by a zeolite LSX.

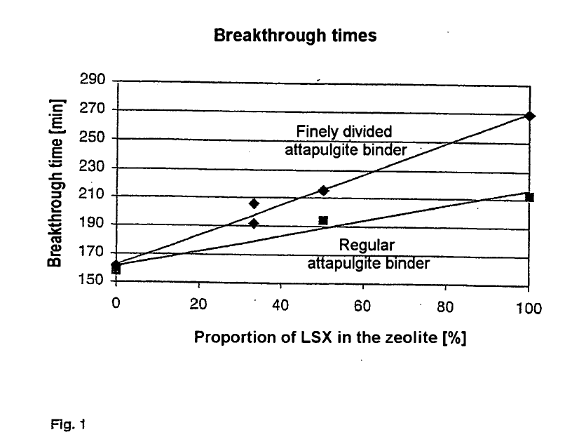

If the conventional clay binder used in these experiments is replaced by a finely divided attapulgite binder, the breakthrough time for a zeolite 13X is virtually identical to that for zeolite 13X with conventional binder. It is 161 minutes. If the zeolite 13X is replaced stepwise by zeolite LSX, the breakthrough time increases more sharply with the finely divided binder than with the conventional binder, namely by 67%, instead of the expected 35%. If pure zeolite LSX is used, the breakthrough time increases to 269 minutes. The result is shown in the table and in FIG. 1.

TABLE
Breakthrough times as a function of
the chosen binder and of the zeolite composition

| | | Finely divided | Conventional |
|---|---|---|---|
| | Proportion | binder | binder |
| | of LSX in | Breakthrough | Breakthrough |
| Experiment | the zeolite | time in | time in |
| number | mixture | minutes | minutes |
| Examples 2 and 4 | 0% | 161 | 158 |
| Example 3 | 33% | 206 | |
| Example 5 | 33% | 192 | |
| Examples 6 and 9 | 50% | 216 | 195 |
| Examples 7 and 8 | 100% | 269 | 213 |

For the results shown in the table, zeolites whose mobile cations were mainly sodium were used. If sodium ions are exchanged for other cations, this results in the formation of adsorption systems which can likewise be used for the purification of gas streams. In particular, potassium and calcium are suitable as further cations.

The shaped zeolite is produced by means of a method which is distinguished by the following process steps:

a) mixing of (i) at least one type of zeolite crystals from the faujasite family having an SiO₂/Al₂O₃ ratio of ≦3.0, in particular zeolite LSX or zeolite LSX and zeolite 13X, with (ii) finely divided attapulgite binder or finely divided attapulgite binder and at least one further clay binder and (iii) addition of water,

b) production of shaped zeolite bodies from the mixture prepared in step a),

c) drying and calcination of the zeolite bodies shaped in step b) in order to obtain the active adsorbent,

the finely divided attapulgite binder being characterized in that its bulk density, measured according to EN ISO 787:1995D, is greater than 550 g/l.

According to step c), an ion exchange can alternatively be effected.

The zeolite 13X crystals and zeolite LSX crystals used in step a) can be prepared by methods known per se, optionally followed by an ion exchange step.

If a mixture comprising different zeolites and/or finely divided attapulgite binder and conventional binder is prepared in step a), the zeolites and the binder can be used as individual components in step a) or the zeolites on the one hand and/or the binders on the other hand can be premixed for use.

The preparation of the attapulgite binder having finely divided attapulgite fibers (finely divided attapulgite binder) and of the conventional attapulgite binder or other clay binder can also be effected by known methods. A suitable finely divided attapulgite binder is obtainable by the method described in U.S. Pat. No. 6,130,179. Such an attapulgite binder has only a low residual content of undispersed attapulgite fiber bundles.

The substantial steps of the method in the preparation of the finely divided attapulgite according to U.S. Pat. No. 6,130,179 are:
crushing of the clay ore,
preparation of an aqueous polyacrylate by adding a polyacrylate, namely a sodium polyacrylate having a molecular weight between 4000 and 5000, to water,
preparation of a slurry of the crushed clay ore in the aqueous polyacrylate, for example by addition of the crushed attapulgite clay ore under moderate to high shear conditions,
separation of the dispersed attapulgite clay from undispersed material, and
drying of the dispersed attapulgite clay.

By means of this method, a finely divided attapulgite clay having the properties important for the finely divided attapulgite of the present invention is obtained. The method is preferably carried out using an amount of from 1 to 4%, based on the weight of the dried clay ore, of sodium polyacrylate and under dispersing conditions under which at least 30% of the attapulgite clay are obtained as dispersed attapulgite. The separation of the dispersed attapulgite clay from undispersed particles can be effected, for example, by sieving, for example through a sieve of 325 mesh, or centrifuging. The dried, finely divided attapulgite usually contains dispersant adsorbed thereon, in particular sodium polyacrylate.

The proportion of the binder in the prepared adsorbent usually accounts for a proportion of between 2 and 30 percent by weight, preferably a proportion of between 5 and 20 percent by weight.

The shaped zeolite may be present in any desired form, for example as small spheres, pills, tablets, etc.

The calcination is preferably effected at about 600° C. for about 30 minutes to 2 hours.

The zeolite 13X used in this invention usually has an SiO₂.Al₂O₃ ratio of 2.3-3.0, preferably between 2.3 and 2.5, and the zeolite LSX used usually has an SiO₂/Al₂O₃ ratio of 2.0-2.3, preferably of about 2.0.

The zeolites contain 75-100%, preferably 95-100%, of sodium. The majority of the remaining cations are potassium.

For special applications, other cations may be present in amounts of up to 95%. For the adsorption of, for example, nitrous oxide, suitable zeolites contain between 60 and 95% of calcium, but preferably between 75 and 85%, the majority of the remaining cations being sodium and potassium.

The zeolites may additionally contain at least one further cation or a plurality of further cations of the alkali metals, of the alkaline earth metals, of the elements of group IIIB or of the lanthanides.

A zeolite which contains at least 10% of LSX is preferred. Particularly suitable mixtures contain from 10 to 95% of LSX and from 90 to 5% of 13X, in particular from 10 to 90% of LSX and from 90 to 10% of 13X, the sum of all zeolites being 100%. Higher proportions of LSX, namely up to 100%, also give very good breakthrough times.

A finely divided attapulgite binder alone or, preferably, as a mixture with conventional clay binders is used as the clay binder. Such a finely divided attapulgite binder may be self-dispersing, for example as mentioned above, it being possible, by mixing finely divided attapulgite binder with conventional attapulgite binder, to limit the total content of dispersant to the amount adsorbed on the finely divided attapulgite binder.

Surprisingly, it was found that only very small proportions of finely divided attapulgite binder are necessary for achieving, together with conventional binder, an improvement in the breakthrough time which is in the range of finely divided attapulgite binder alone. As little as 10% of finely divided binder or 90% of conventional binder give a marked improvement. According to the invention, binder mixtures comprising 10 to 90% of finely divided attapulgite binder together with one or more conventional binder are therefore preferably employed, the sum of finely divided attapulgite binder and conventional binders being 100%. This is very advantageous both from the economic point of view and from the ecological point of view. However, the proportion of conventional binder is advantageously not more than 80%, in particular not more than 70%.

While the finely divided binder is an attapulgite binder, the conventional binders may be any binders suitable for the shaping of zeolites, i.e. in addition to attapulgite, for example, also kaolin, bentonite, montmorillonite, sepiolite and the like or mixtures of such clay binders.

In a special embodiment, in addition to finely divided attapulgite binder, kaolin is used as the conventional binder and, after calcination, is optionally converted at least partly into zeolite in an aftertreatment step.

During the shaping, customary additives may be added, in particular organic additives, such as pore-forming auxiliaries. The pore-forming auxiliaries include, for example, fibers, such as rayon, nylon, sisal and flax, and additionally also organic polymers, such as starch, starch derivatives, ligninsulfonates, polyacrylamides, polyacrylic acids, cellulose and cellulose derivatives. The amount of the added pore-forming substances is usually between 2 and 15 percent by weight, based on the finished product.

The adsorption of trace gases is effected in one or more adsorbers which are preferably connected in parallel. The laden adsorbers are regenerated by suitable methods. The adsorption process can be carried out either in the TSA (temperature swing adsorption) or in the PSA (pressure swing adsorption) mode, the TSA mode being preferred.

By means of the adsorption system according to the invention, extremely high adsorption capacities, combined with short mass transfer zones, are achieved and hence a longer on-stream time of the adsorption systems before breakthrough of carbon dioxide occurs.

In addition to a method for the production of the shaped zeolite, this invention also relates to a shaped zeolite obtainable by this method and a gas purification method using this zeolite.

In the method for eliminating one or more impurities from a gas stream, the gas stream is passed through a bed of the zeolitic adsorbent according to the invention.

A preferred gas stream is an air stream comprising impurities which can be eliminated from gas streams by means of the zeolite according to the invention. The impurities comprise carbon dioxide, water, nitrous oxide, another inorganic gas, hydrocarbons and mixtures of two or more of these substances. An impurity for the elimination of which the zeolites according to the invention are particularly suitable is carbon dioxide. Particularly in the case of mixtures of impurities which are to be eliminated, the bed may comprise a bed of different zeolites, it being possible for the zeolites according to the invention alone or in combination with conventional zeolites to be present.

The invention is now explained further with reference to a few examples. These examples are intended to serve for illustration and in no way to limit the invention.

### EXAMPLES

The zeolite powders used in the examples were obtained from Zeochem AG, Uetikon. The finely divided attapulgite binder and the conventional attapulgite binder were obtained from ITC Floridin.

### Example 1

Synthesis of the Zeolite LSX and of the Zeolite 13X

The synthesis of the zeolite LSX is effected by a method described in the literature, for example according to GB 1,580,928. The product obtained has an SiO₂/Al₂O₃ ratio close to 2.0. The cations comprise 20-30% of potassium and 70-80% of sodium. The zeolite as obtained after the synthesis is referred to as NaK-LSX. The ratio of the cations can be changed by an ion exchange carried out in a classical manner. If the synthesized product is treated with sodium ions, a zeolite LSX which contains sodium ions up to a degree of exchange of 99% is obtained. This zeolite is usually referred to as Na-LSX. An analogous procedure is adopted if a zeolite having another cation is desired. The various cations have a decisive influence on the adsorption capacity of carbon dioxide, nitrous oxide or hydrocarbons.

The synthesis of the zeolite 13X is likewise effected by a method described in the literature, for example as described in H. Robson, “Verified syntheses of zeolitic materials”, Elsevier, 2001, pages 150-151.

### Example 2

Preparation of Granulated Molecular Sieve 13X Using Conventional Attapulgite Binder for Air Purification (Comparative Example)

A mixture of 13X zeolite powder, organic additives (pore formers) and a conventional attapulgite clay binder (proportion of binder 16%) was introduced continuously into a granulating pan. During the granulation process, water was sprayed onto the powder mixture in order to maintain a constant moisture content, as required for addition of powder during the process. The powder mixture was metered in at a rate of 500 kg/h. After the entire powder mixture had been introduced, the resulting spheres were rolled for a further 10 minutes. The resulting green particles were sieved to obtain the 1.6-2.6 mm fraction, dried at 100° C. and then calcined at 620° C. The calcined and then cooled material was packed in containers having an air-tight seal and analyzed. The breakthrough time of carbon dioxide which as achieved was 158 minutes.

### Example 3

Preparation of Granulated Molecular Sieve 13X/LSX Using Finely Divided Binder for Air Purification (According to the Invention)

A mixture of Na-LSX zeolite powder and 13X zeolite powder (mixed in the ratio 33:67), organic additives (pore formers) and a mixture of finely divided attapulgite clay binder with conventional attapulgite binder (mixing ratio 33:67; total proportion of the binder 12%) was introduced continuously into a granulating pan. During the granulation process, water was sprayed onto the powder mixture in order to maintain a constant moisture content, as required for the addition of powder during the process. The powder mixture was metered in at a rate of 500 kg/h. After the entire powder mixture had been introduced, the resulting spheres were rolled for a further 10 minutes. The resulting green particles were sieved to obtain the 1.6-2.6 mm fraction, dried at 100° C. and then calcined at 620° C. The calcined and then cooled material was packed in containers having an air-tight seal and analyzed. The breakthrough time of carbon dioxide which was achieved was 206 minutes.

### Examples 4-9

Preparation of Granulated Molecular Sieve 13X/LSX Using Finely Divided Binder for Air Purification

Mixtures of zeolite powders having different compositions were prepared. These mixtures were further mixed with organic additives (pore formers) and clay binders and moistened. 2 kg of these mixtures were granulated in an R02 Eirich intensive mixer until uniform zeolite spheres formed. The green particles were sieved to obtain a sphere size of 1.6-2.6 mm, dried at 100° C. and then calcined at 620° C. The calcined and then cooled material was packed in containers having an air-tight seal and analyzed.

In example 4, only molecular sieve 13X was used. For the granulation, a binder mixture comprising a finely divided attapulgite binder and a conventional attapulgite binder, mixed in the ratio of 50:50, was used (proportion of binder 12%). The breakthrough time achieved was 161 minutes.

In example 5, the molecular sieve 13X and molecular sieve LSX were used in the ratio 67:33. For the granulation, a binder mixture comprising a finely divided attapulgite binder and a conventional attapulgite binder, mixed in the ratio of 50:50, was used (proportion of binder 12%). The breakthrough time achieved was 192 minutes.

In example 6, molecular sieve 13X and molecular sieve LSX were used in the ratio 50:50. For the granulation, a binder mixture comprising a finely divided attapulgite binder and a conventional attapulgite binder, mixed in the ratio 50:50, was used (proportion of binder 12%). The breakthrough time achieved was 216 minutes.

In example 7, only molecular sieve LSX was used. For the granulation, a binder mixture comprising a finely divided attapulgite binder and a conventional attapulgite binder, mixed in the ratio of 50:50, was used (proportion of binder 12%). The breakthrough time achieved was 269 minutes.

In example 8 (comparative example), only molecular sieve LSX was used. The binder used was a conventional attapulgite (proportion of binder 16%). The breakthrough time achieved was 213 minutes.

In example 9 (comparative example), molecular sieve 13X and molecular sieve LSX were used in the ratio 50:50. For the granulation, a conventional attapulgite was used (proportion of binder 16%). The breakthrough time achieved was 195 minutes.

### Example 10

Determination of the Breakthrough Time

The molecular sieve to be analyzed is introduced into an adsorption vessel of 30 mm diameter. At a pressure of 6×10⁵ Pa, a temperature of 25° C. and a flow rate of 2.4 m³/h, purified nitrogen to which 450 ppm of carbon dioxide has been added is allowed to flow through. An infrared detector is used to determine the time after which the carbon dioxide appears at the end of the adsorption vessel. This time is designated as breakthrough time and is noted.

By means of this method, the breakthrough times mentioned in this invention were determined (cf. for example table).

While preferred embodiments of the invention are described in the present Application, it should be made clear that the invention is not limited to these and can also be carried out in other ways within the scope of the following claims.

1. A method for the production of shaped zeolites, characterized by the process steps of:
a) mixing of (i) at least one type of zeolite crystal from the faujasite family having an SiO₂/Al₂O₃ ratio of ≦3.0, (ii) finely divided attapulgite binder, or finely divided attapulgite binder and at least one further clay binder, the finely divided attapulgite binder being characterized in that its bulk density, measured according to EN ISO 797:1995D, is greater than 550 g/l, and (iii) water,
b) producing shaped zeolite bodies from the mixture prepared in step a),
c) drying and calcinating of the zeolite bodies shaped in step b) in order to obtain an active absorbent.

2. The method as claimed in claim 1, characterized in that an ion exchange is effected after step c).

3. The method as claimed in claim 1, characterized in that the proportion of the binder in the finished adsorbent accounts for a proportion of between 2 and 30 percent by weight.

4. The method as claimed in claim 3, characterized in that the proportion of the binder in the finished adsorbent accounts for a proportion of between 5 and 20 percent by weight.

5. The method as claimed in claim 1, characterized in that not more than 10 to 90% of the binder is conventional clay binder.

6. The method as claimed in claim 5, characterized in that not more than 80% of the binder is conventional clay binder.

7. The method as claimed in claim 5, characterized in that not more than 70% of the binder is conventional clay binder.

8. The method of claim 1, wherein the at least one type of zeolite crystal from the faujasite family having an SiO₂/Al₂O₃ ratio of ≦3.0 is selected from the group consisting of zeolite LSX and zeolite 13X.

9. The method as claimed in claim 8, characterized in that the zeolite types 13X and LSX are used in a ratio of from 90:10 to 5:95.

10. The method as claimed in claim 8, characterized in that at least 70% of the two zeolite types 13X and LSX are present in the sodium form.

11. The method as claimed in claim 8, characterized in that at least 90% of the two zeolite types 13X and LSX are present in the sodium form.

12. The method as claimed in claim 8, characterized in that not more than 30% of the two zeolite types 13X and LSX are present in the potassium form.

13. The method as claimed in claim 8, characterized in that not more than 10% of the two zeolite types 13X and LSX are present in the potassium form.

14. The method as claimed in claim 8, characterized in that from 60 to 95% of the two zeolite types 13X and LSX are present in the calcium form.

15. The method as claimed in claim 8, characterized in that between 75 and 85% of the two zeolite types 13X and LSX are present in the calcium form.

16. The method as claimed in claim 1, characterized in that a pore-forming agent is added to the mixture of the zeolite crystals and the binder.

17. The method as claimed in claim 16, characterized in that the pore-forming agent is added in an amount which corresponds to an amount between 2 and 15 percent by weight, based on the finished product.

18. A zeolitic adsorbent obtainable by means of the method as claimed in claim 1.

19. A method for eliminating one or more impurities from a gas stream, characterized in that the gas stream is passed through a bed of the zeolitic adsorbent as claimed in claim 18.

20. The method as claimed in claim 19, characterized in that the gas stream is an air stream and the impurity is selected from the group consisting of carbon dioxide, water, nitrous oxide, another inorganic gas, hydrocarbons and mixtures of two or more of these substances.

21. The method as claimed in claim 19, characterized in that the impurity is carbon dioxide.

22. The method as claimed in claim 21, characterized in that the eliminating one or more impurities is effected alternately with a desorption in the PSA mode or in particular in the TSA mode.

23. The method as claimed in claim 21, wherein in that the eliminating one or more impurities is effected alternately with a desorption in the TSA mode.
